(19) United States
(12) Patent Application Publication
(10) Pub. No.: US 2016/0320972 A1
(43) Pub. Date: Nov. 3, 2016

(54) ADAPTIVE COMPRESSION-BASED PAGING

(71) Applicant: QUALCOMM INCORPORATED, San Diego, CA (US)

(72) Inventors: Gurvinder Singh Chhabra, San Dirgo, CA (US); Andres Alejandro Oportus Valenzuela, San Diego, CA (US)

(21) Appl. No.: 14/699,714

(22) Filed: Apr. 29, 2015

(51) Int. Cl. G06F 3/06

(52) U.S. Cl. CPC G06F 3/064; G06F 3/0608; G06F 3/0673

(57) ABSTRACT

Systems, methods, and computer programs are disclosed for adaptive compression-based demand paging. Two or more compressed software image segments are stored in each of one or more memories. Each compressed software image segment corresponds to at least one software task and includes one or more pages that are compressed in accordance with a compression characteristic different from that of the other software image segments. If it is determined that a page request associated with an executing software task identifies a page that is not stored in the system memory, then a portion of the compressed software image segment containing the identified page is decompressed, and the decompressed page is stored in the system memory.

### DESCRIPTION OF THE RELATED ART

A computing device, such as a desktop, laptop or tablet computer, smartphone, portable digital assistant, portable game console, etc., includes one or more processors, such as central processing units, graphics processing units, digital signal processors, etc. Other electronic devices, such as computer peripheral devices, as well as consumer electronics devices that have not traditionally been referred to as computing devices, may also include one or more processors. In computing and other devices, such a processor reads instructions or software code from a system memory with which the processor communicates via one or more buses, and performs or manages tasks in accordance with its execution of the code. A processor may be programmed in this manner to manage multiple tasks. A unit of code and data that may be referred to for convenience as a software image may support a processor's management of on the order of hundreds or even thousands of tasks. To promote high throughput, the system memory may be of a type capable of high-speed operation, such as double data rate dynamic random access memory (DDR-DRAM).

Some types of devices, such as portable devices, may have a relatively limited amount of system memory (storage) capacity, such that the memory is incapable of storing the entire software image. A technique commonly known as demand paging may be employed to address this problem. In demand paging, a subset of the software image is stored in a secondary memory and transferred into the system memory in units of pages on an as-needed basis in response to page requests initiated by the processor. The secondary memory may be of a type that is slower than the system memory. Consequently, demand paging may impact the performance of tasks that require a processor to access memory faster than the secondary memory allows.

A demand paging technique has been developed in which a subset of the software image is stored in a compressed form in system memory. In response to a page request initiated by the processor, a portion of the software image is decompressed, and the resulting page is then stored in the system memory for access by the processor.

### SUMMARY OF THE DISCLOSURE

Systems, methods, and computer programs are disclosed for demand paging in an adaptive, compression-based manner.

In exemplary methods for demand paging, a plurality of compressed software image segments are stored in a memory. Each compressed software image segment corresponds to at least one software task of a plurality of software tasks. Each compressed software image segment comprises one or more pages that are compressed in accordance with a compression characteristic associated with the compressed software image segment and that is different from the compression characteristics of the other compressed software image segments. In response to a page request associated with an executing software task, it is determined whether the page request identifies a page stored in the memory. If the identified page is not stored in the memory, then a portion of one of the compressed software image segments containing the identified page is decompressed into a decompressed page. The decompressed page is then stored in the memory.

Exemplary systems for demand paging include a memory and a processor. The memory is configured to store a plurality of compressed software image segments. Each compressed software image segment corresponds to at least one software task of a plurality of software tasks. Each compressed software image segment comprises one or more pages compressed in accordance with a compression characteristic associated with the compressed software image segment and that is different from compression characteristics of the other compressed software image segments. The processor is configured to: determine whether a page request associated with an executing software task identifies a page stored in the memory; decompress a portion of one of the compressed software image segments containing an identified page into a decompressed page if the identified page is not stored in the memory; and store the decompressed page in the memory in response to the page request.

Exemplary computer program products for demand paging include computer-executable logic embodied in a non-transitory storage medium. Execution of the logic by the processor configures the processor to: determine whether a page request associated with an executing software task identifies a page stored in a memory, wherein the memory has stored therein a plurality of compressed software image segments, each compressed software image segment corresponding to at least one software task of a plurality of software tasks, and wherein each compressed software image segment comprises one or more pages compressed in accordance with a compression characteristic associated with the compressed software image segment and that is different from compression characteristics of the other compressed software image segments; decompress a portion of one of the compressed software image segments containing an identified page into a decompressed page if the identified page is not stored in the memory; and store the decompressed page in the memory in response to the page request.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a processing system for compression-based demand paging, in accordance with an exemplary embodiment.

FIG. 2 is a flow diagram illustrating an exemplary method for compression-based demand paging, in accordance with an exemplary embodiment.

FIG. 3 is a chart illustrating relationships or associations among tasks, compressed software image segments, and compression logic elements, in accordance with an exemplary embodiment.

FIG. 4 is similar to FIG. 3, further illustration associations with clock and voltage settings.

FIG. 5A is a flow diagram similar to FIG. 2.

FIG. 5B is a continuation of the flow diagram of FIG. 5A.

FIG. 6 is a front view of a modem having the system of FIG. 1, showing the modem connected to the USB port of a laptop computer, in accordance with an exemplary embodiment.

FIG. 7 is a block diagram of a computer with a processor having the system of FIG. 1, in accordance with an exemplary embodiment.

FIG. 8 is a block diagram of a portable communication device having the system of FIG. 1, in accordance with an exemplary embodiment.

FIG. 9A is a flow diagram similar to FIGS. 2 and 5A-5B.

FIG. 9B is a continuation of the flow diagram of FIG. 9A.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets (e.g., data from one component interacting with another component in a local system, distributed system, and/or across a network such as the Internet with other systems by way of the signal).

The term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

The term “task” may include a process, a thread, or any other unit of execution in a device.

The term “virtual memory” refers to the abstraction of the actual physical memory from the application or image that is referencing the memory. A translation or mapping may be used to convert a virtual memory address to a physical memory address. The mapping may be as simple as 1-to-1 (e.g., physical address equals virtual address), moderately complex (e.g., a physical address equals a constant offset from the virtual address), or the mapping may be complex (e.g., every 4 KB page mapped uniquely). The mapping may be static (e.g., performed once at startup), or the mapping may be dynamic (e.g., continuously evolving as memory is allocated and freed).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. The term “portable computing device” (“PCD”) is used to describe any device operating on a limited-capacity power supply, such as a battery, and lacking a system for removing excess thermal energy (i.e., for cooling, such as a fan, etc.). A PCD may be a cellular telephone, a satellite telephone, a pager, a PDA, a smartphone, a navigation device, a smartbook or reader, a media player, a laptop or hand-held computer with a wireless connection, or a combination of the aforementioned devices, among others.

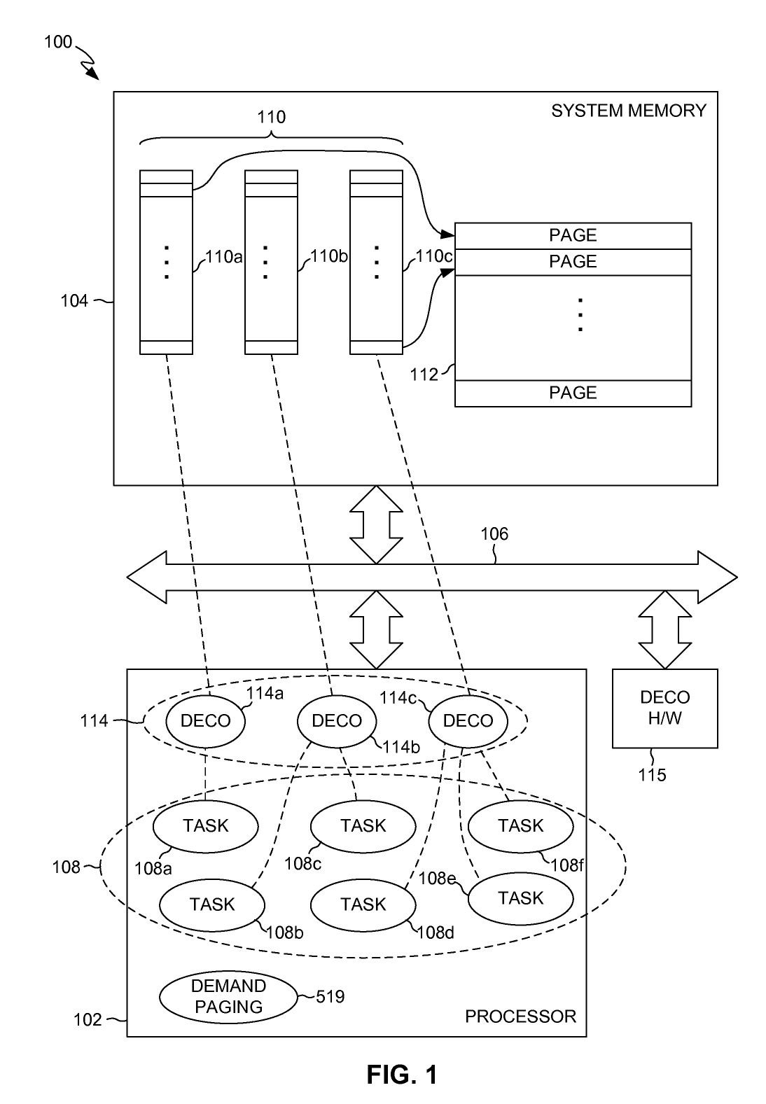

As illustrated in FIG. 1, in an exemplary embodiment a system 100 comprises a processor 102 and a system memory 104. Processor 102 and system memory 104 communicate via a data bus system 106. Processor 102 is configured through software, i.e., programming, to control or manage multiple tasks 108. Tasks 108 may comprise, for example, six tasks 108a, 108b, 108c, 108d, 108e and 108f. Although these six tasks 108a-108f are described herein for purposes of illustration in relation to an exemplary embodiment, any other number of tasks 108 may exist in other embodiments. As understood by one of ordinary skill in the art, a unit of code and data that may be referred to for convenience as a “software image” may support a processor's control or management of on the order of hundreds or even thousands of tasks 108. Although in FIG. 1 tasks 108a-108f are conceptually depicted for purposes of illustration as residing within processor 102, one of ordinary skill in the art appreciates that tasks 108a-108f are defined by logic that arises in processor 102 under the control of software.

In the exemplary embodiment, a form of demand paging is employed because, for example, memory 104 may not have sufficient storage capacity to contain the entire software image associated with the control by processor 102 of tasks 108a-108f. Nevertheless, in other embodiments, the methods and systems described herein may be employed regardless of whether there is sufficient system memory to contain the software image. As described below in further detail, the demand paging method employs data compression.

In the exemplary embodiment, a portion of the software image is compressed to form two or more compressed software image segments 110. Compressed software image segments 110 may comprise, for example, three compressed software image segments 110a, 110b and 110c. Compressed software image segments 110a-110c are stored in memory 104. Although these three compressed software image segments 110a-110c are described herein for purposes of illustration in relation to an exemplary embodiment, any other number of compressed software image segments 110 may exist in other embodiments. Although compressed software image segments 110a, 110b and 110c are illustrated for purposes of clarity as being separated from one another, they may occupy contiguous memory address space.

Another portion of the software image may also be stored in memory 104 in an uncompressed form. Some or all of this uncompressed portion of the software image may be in the form of a page pool 112. Although page pool 112 is illustrated for purposes of clarity as being separate from compressed software image segments 110, page pool 112 and compressed software image segments 110 may occupy contiguous memory address space.

Each of compressed software image segments 110a-110c comprises one or more pages compressed in accordance with a unique compression characteristic. That is, compressed software image segment 110a is compressed in accordance with a compression characteristic that differs from the compression characteristics with which compressed software image segments 110b and 110c are respectively compressed; compressed software image segment 110b is compressed in accordance with a compression characteristic that differs from the compression characteristics with which compressed software image segments 110a and 110c are respectively compressed; and compressed software image segment 110c is compressed in accordance with a compression characteristic that differs from the compression characteristics with which compressed software image segments 110a and 110b are respectively compressed. As described in further detail below, the compression characteristic may be, for example, compression algorithm, compression block size, or a combination of compression algorithm and compression block size.

Each of compressed software image segments 110 is associated with at least one of tasks 108. For example, as illustrated in FIG. 1, compressed software image segment 110a is associated with task 108a; compressed software image segment 110b is associated with tasks 108b and 108c; and compressed software image segment 110c is associated with task 108d, 108e and 108f. In FIG. 1, the dashed or broken line between one of the compressed software image segments 110 and one of the tasks 108 indicates such an association. It should be understood that the associations between compressed software image segments 110 and tasks 108 shown in FIG. 1 are intended only to be exemplary, i.e., for purposes of illustration in relation to an exemplary embodiment.

Decompression logic 114 is also associated with compressed software image segments 110 and tasks 108, as indicated in FIG. 1 by decompression logic elements 114a, 114b and 114c. Each of decompression logic elements 114a, 114b and 114c represents logic that performs decompression in accordance with a unique compression characteristic. That is, decompression logic element 114a performs decompression in accordance with a compression characteristic that differs from the compression characteristics with which decompression logic elements 114b and 114c respectively perform decompression; decompression logic element 114b performs decompression in accordance with a compression characteristic that differs from the compression characteristics with which decompression logic elements 114a and 114c respectively perform decompression; and decompression logic element 114c performs decompression in accordance with a compression characteristic that differs from the compression characteristics with which decompression logic elements 114a and 114b respectively perform decompression. Although decompression logic elements 114a, 114b and 114c are illustrated in FIG. 1 for purposes of clarity as distinct from one another, one of ordinary skill in the art appreciates that their logic may overlap, in the sense that they may share some common software features. Further, one or more of decompression logic elements 114a-114c may offload some or all of the work of decompression to hardware-based decompression logic 115. Also, although in FIG. 1 decompression logic elements 114a-114c and tasks 108a-108f are conceptually depicted for purposes of illustration as residing within processor 102, one of ordinary skill in the art appreciates that these elements are defined by logic that arises by execution of software in processor 102.

As described below with regard to an exemplary method, each of compressed software image segments 110a, 110b and 110c comprises one or more pages that may be decompressed into page pool 112. Decompression logic element 114a may be employed to decompress portions of software image segment 110a. Decompression logic element 114b may be employed to decompress portions of software image segment 110b. Decompression logic element 114c may be employed to decompress portions of software image segment 110c.

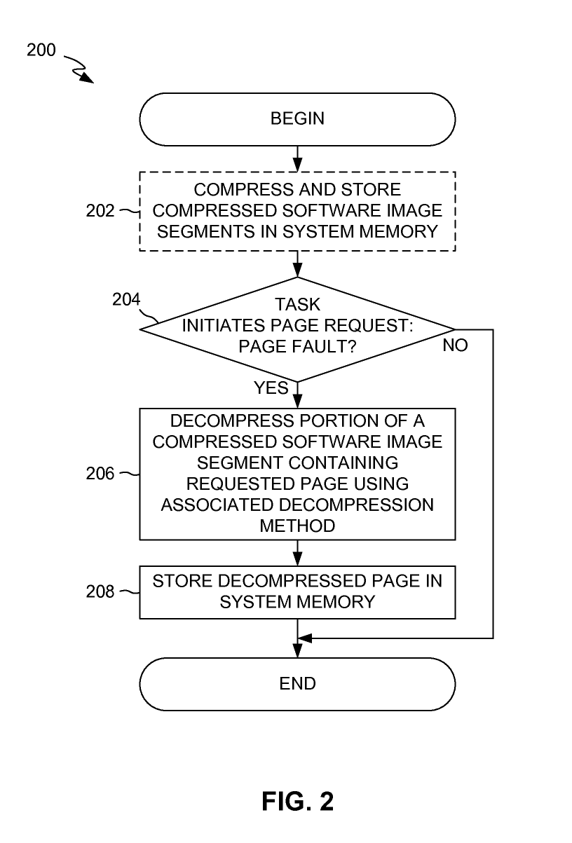

As illustrated in FIG. 2, in an exemplary embodiment a method 200 relates to demand paging in, for example, the above-described system 100. As indicated by block 202, compressed software image segments 110a, 110b and 110c are generated and stored in memory 104. A software tool (not shown) may be employed to generate and store compressed software image segments 110a, 110b and 110c. Software image segments 110a, 110b and 110c may be generated and stored in advance of the operation of tasks 108. The time during which tasks 108 are in operation is commonly referred to as “run time” or “execution time,” in contrast with an earlier time at which various logic elements are initialized and stored, which is commonly referred to as “build time.” A manner in which such a software tool may be employed at build time is described more fully below. In FIG. 1, block 202 is depicted in broken line to indicate a build-time act or step in the method flow in the exemplary embodiment as opposed to a run-time act or step. Nevertheless, in other embodiments acts or steps may occur at other times.

As indicated by block 204, one of tasks 108a-108f may initiate a page request. As well understood by one of ordinary skill in the art, a page request may occur when the processing system attempts to access a system memory address within a unit of memory space known as a page at a time at which the portion of the software image corresponding to that page is not resident in memory. Paging is described in further detail below.

As indicated by block 206, in response to a page request, a portion of the compressed software image containing the requested page is decompressed. The decompression is performed using decompression logic 114 that is associated with the one of compressed software image segments 110 that contains the requested page (in compressed form). Thus, in the exemplary embodiment illustrated in FIG. 1, in an instance in which task 108a requests a page contained within compressed software image segment 110a, decompression logic 114a decompresses the requested page. Similarly, in an instance in which task 108b or 108c requests a page contained within compressed software image segment 110b, decompression logic 114b decompresses the requested page. Likewise, in an instance in which task 108d, 108e or 108f requests a page contained within compressed software image segment 110c, decompression logic 114c decompress the requested page. As indicated by block 208, the decompressed page is then stored in page pool 112 in system memory 104 (FIG. 1).

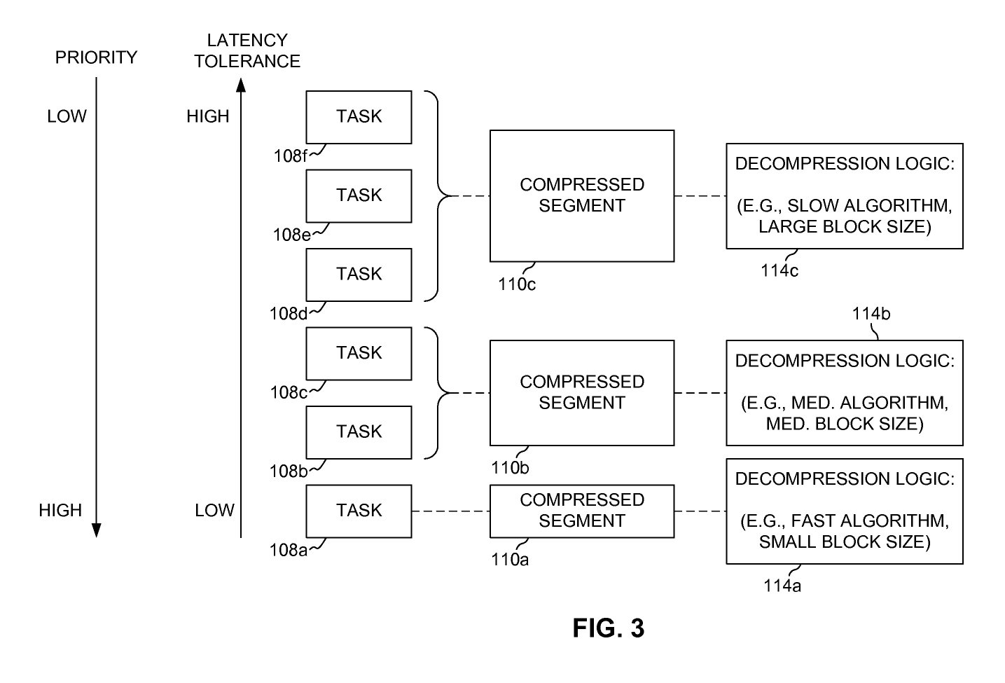

As illustrated in FIG. 3, tasks 108a-108f are shown ranked or arranged in order of their relative latency tolerance (and corresponding priority). “Latency” is the amount of time between a task 108 initiating a page request and the page becoming available in page pool 112. “Latency tolerance” refers to the degree to which the latency exceeding a nominal value or threshold affects the performance of the task. In FIG. 3, task 108a has the lowest latency tolerance among tasks 108a-108f. For this reason, compressed software image segment 110a, which is associated with task 108a, is compressed in accordance with a compression characteristic that provides fast decompression. As noted above, such a compression characteristic may comprise the compression algorithm, the compression block size, or a combination of both. It is well understood by one of ordinary skill in the art that some algorithms decompress data faster than other algorithms. (A tradeoff is a generally inverse relationship between decompression speed and compression ratio.) It is also well understood by one of ordinary skill in the art that schemes in which data is compressed in small block sizes generally facilitate faster decompression than schemes in which data is compressed in larger block sizes. Accordingly, decompression logic element 114a may be characterized by, for example, a fast compression algorithm and a small block size.

In FIG. 3, task 108b has a latency tolerance that is greater than the latency tolerance of task 108a but less than the latency tolerance of task 108c (which may be referred to as a “medium” latency tolerance in this embodiment for illustrative purposes). Tasks 108b and 108c may have similar enough latency tolerances that they are grouped together relative to the other tasks 108. Accordingly, compressed software image segment 110b, which is associated with both tasks 108b and 108c, is compressed in accordance with a compression characteristic that provides slower decompression than the characteristic with which compressed software image segment 110a is compressed but faster decompression than the characteristic with which compressed software image segment 110c is compressed. Accordingly, decompression logic element 114b may be characterized by, for example, a slower compression algorithm and a larger block size than the algorithm and block size that characterize decompression logic element 114a (i.e., a “medium”-speed algorithm and a “medium” block size).

Continuing in order of latency tolerance, it can be noted that task 108d has a higher latency tolerance than task 108c, task 108e has a higher latency tolerance than task 108d, and task 108f has the highest latency tolerance among tasks 108a-108f. Tasks 108d-108f may have similar enough latency tolerances that they are grouped together relative to the other tasks 108. Accordingly, compressed software image segment 110c, which is associated with each of tasks 108d-108f, is compressed in accordance with a compression characteristic that provides slower decompression than the characteristic with which compressed software image segment 110b is compressed. Accordingly, decompression logic element 114c may be characterized by, for example, a slower compression algorithm and a larger block size than the algorithm and block size that characterize decompression logic element 114b.

A further differentiation in decompression speed may be provided in an exemplary embodiment by employing hardware-based decompression logic 115 in the decompression of only those of software image segments 110 corresponding to tasks 108 having lower latency tolerances or higher priorities. For example, decompression logic element 114a may offload the work of decompression to hardware-based decompression logic 115, while decompression logic elements 114b and 114c perform the work of decompression themselves (i.e., as software-based computations, without the aid of hardware-based decompression logic 115). Alternatively, decompression logic elements 114a and 114b may offload the work of decompression to hardware-based decompression logic 115, while decompression logic element 114c performs the work of decompression.

In some instances, there may be an inverse relationship between a task's latency tolerance and the task's priority. “Priority” of a task relates to the degree to which the performance a task in relation to the performance of other tasks affects performance results of a system encompassing the tasks. A task that affects system performance to a greater extent than another task may be assigned a higher priority than the other task. A task may have a higher latency tolerance and a lower priority than some other tasks. Conversely, a task may have a lower latency tolerance and a higher priority than some other tasks.

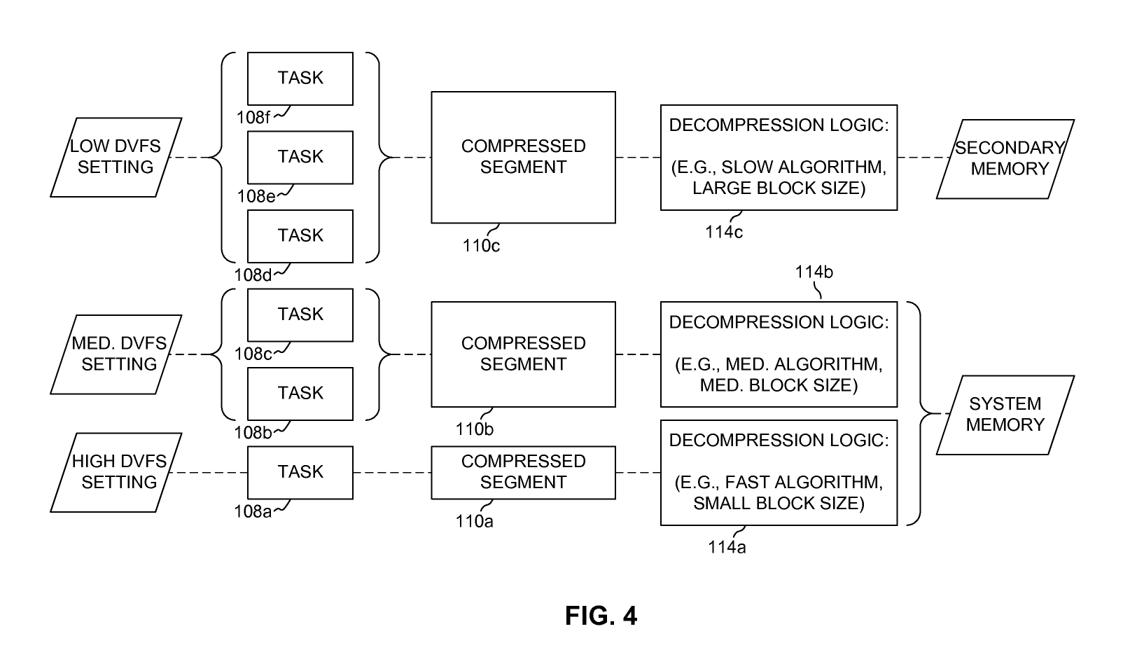

In the exemplary embodiment, the system clock and/or voltage level may be adjusted using, for example, dynamic voltage and frequency scaling (DVFS) techniques in response to the priority of a task. As illustrated in FIG. 4, in the exemplary embodiment each group of tasks 108 is associated with a unique DVFS level or setting. Correspondingly, each compressed software image segment 110 is associated with a unique DVFS level or setting. For example, task 108a, and correspondingly, compressed software image segment 110a, are associated with a “high” DVFS setting that enables system 100 (FIG. 1) or portions thereof (e.g., processor 102) to operate at a high speed. Tasks 108b and 108c, and correspondingly, compressed software image segment 110b, are associated with a “medium” DVFS setting that enables system 100 or portions thereof to operate at a medium speed. Tasks 108d-108f, and correspondingly, compressed software image segment 110c, are associated with a “low” DVFS setting that enables system 100 or portions thereof to operate at a low speed. Thus, in the exemplary embodiment, the higher the priority of a task 108, the faster the system may operate.

In the exemplary embodiment, software image segments associated with higher-priority tasks may be compressed and stored in a system memory that is characterized by low latency (i.e., high access speed), while software image segments associated with lower-priority tasks may be compressed and stored in a secondary memory that is characterized by a higher latency (i.e., lower access speed) than the system memory. For example, as conceptually illustrated in FIG. 4, compressed software image segments 110a and 110b may be associated with storage in a system memory while compressed software image segment 110c may be associated with storage in a secondary memory. Examples of such system memory and secondary memory are described below.

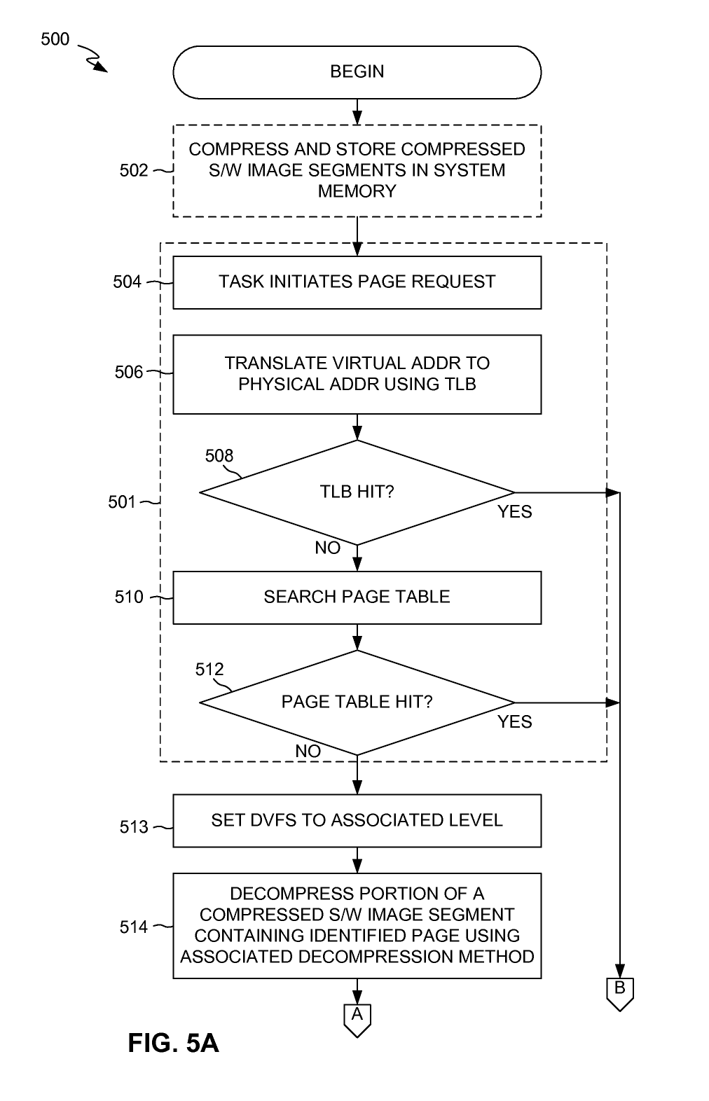

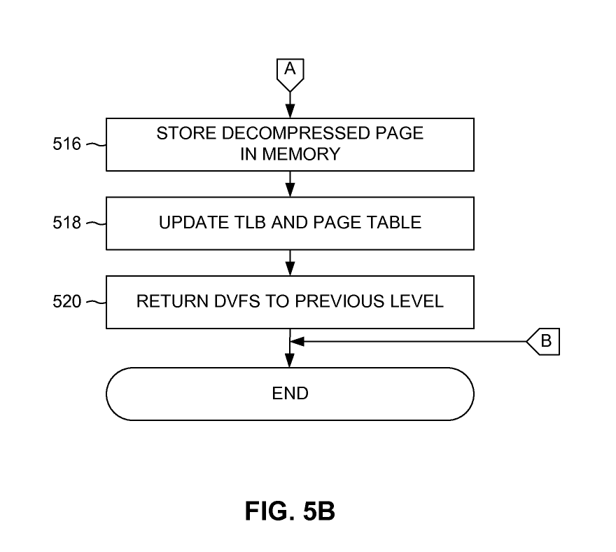

In FIGS. 5A5B, an exemplary method 500 that is similar to the above-described exemplary method 200 is illustrated. Block 502 is similar to above-described block 202. A software tool (not shown) may be employed to generate compressed software image segments 110. The tool receives the software image and the compression characteristics as inputs. The tool may also receive information identifying the various tasks 108 and their respective latency tolerances and/or priorities. Such information may be determined empirically or in other ways, as understood by one of ordinary skill in the art. The tool maintains an ordered list of tasks 108, ranked in order of latency tolerance and/or priority, as described above with regard to FIGS. 3-4. The tool may include a plurality of compression algorithms and compression block sizes and associate each group of one or more of the tasks 108 with a combination of compression algorithm and block size that achieves a latency tolerance and/or priority corresponding to the ranking. The tool may use these inputs to generate compressed software image segments 110 for storage in memory 104.

Block 501 is similar to above-described block 204. In further detail, block 501 comprises blocks 504, 506, 508, 510 and 512. As indicated by block 504, one of tasks 108a-108f may initiate a page request. A page request is identified by a virtual address of the requested page. As indicated by block 506, the virtual address may be translated into a physical address in memory 104 using a translation lookaside buffer or “TLB” (not shown). As indicated by block 508, it is determined whether the physical address is present in the TLB. A determination that a physical address is present in the TLB is commonly referred to as a “TLB hit.” A determination that a physical address is not present in the TLB is commonly referred to as a “TLB miss.” If it is determined that a TLB hit did not occur (i.e., a TLB miss occurred), it is then determined whether the physical address is present in a page table (not shown), as indicated by block 510. A determination that a physical address is present in the page table is commonly referred to as a “page table hit.” A determination that a physical address is not present in the page table is commonly referred to as a “page table miss.” If it is determined that neither a TLB hit nor a page table hit occurred (i.e., both a TLB miss and a page table miss occurred), then a portion of the one of software image segments 110a-110c that is associated with the requesting one of tasks 108a-108f is decompressed. As described above with regard to block 206, which is similar to block 514, this decompression is performed using the one of decompression logic elements 114a-114c associated with the one of compressed software image segments 110a-110C containing the requested page.

As indicated by block 513, in conjunction with the paging and decompression described above, system 100 (FIG. 1) may be adjusted to set a DVFS characteristic, such as voltage or clock frequency, to a setting or level associated with the requesting task 108 (and correspondingly, associated with one of the compressed software image segments 110a-110c containing the requested page). For example, the DVFS characteristic may be set temporarily and used while decompression is being performed, then returned to its previous setting. Of course, if the DVFS characteristic is already set to a level or setting associated with the requesting task 108, it need not be set again to the same level or setting per block 513, and can remain at its then-current setting.

Continuing to FIG. 5B, as indicated by block 516, which is similar to above-described block 208, the decompressed page is then stored in page pool 112 in memory 104.

As indicated by block 518, the decompressed page is mapped into the page table and TLB. As the management of a TLB and page table are well understood by one of ordinary skill in the art, further details of such processes are not described herein. Demand paging logic 519 (FIG. 1) may contribute to configuring processor 102 to control the above-described paging, while decompression logic elements 114 may contribute to configuring processor 102 to control the above-described decompression.

As indicated by block 520, the DVFS characteristic may be returned to its previous setting following the above-described decompression. However, in an instance in which two or more decompressions are to be performed in immediate succession, and following one such decompression the DVFS characteristic is already set to a level or setting associated with the requesting task 108 associated with the next decompression, the DVFS characteristic need not be returned to its previous level or setting per block 520, and can remain at its then-current setting. Following the above-described paging, decompression and DVFS adjustment, the requesting task 108 may access the decompressed page in memory 104 and otherwise continue to execute.

If it is determined that there was a hit in either the TLB or the page table, then neither the decompression described above with regard to blocks 514 and 516 nor the DVFS adjustment described above with regard to block 520 are performed. As a page hit indicates that the requested page is already in memory 104, the requesting task may access the page and otherwise continue to execute.

It should be appreciated that one or more of the method steps or acts described above may be stored in memory 104 as computer program instructions. These instructions may be executed by any type of processor 102 in any type of device to perform the methods described herein.

Although certain acts or steps in the above-described process flows naturally precede others for the exemplary embodiments to operate as described, the invention is not limited to the order of those acts or steps if such order or sequence does not alter the functionality of the invention. That is, it is recognized that some acts or steps may be performed before, after, or parallel (substantially simultaneously with) other acts or steps without departing from the scope and spirit of the invention. In some instances, certain acts or steps may be omitted or not performed without departing from the invention. Further, words such as “thereafter,” “then,” “next,” etc., are not intended to limit the order of the acts or steps. These words are simply used to guide the reader through the descriptions of the exemplary methods.

Additionally, one of ordinary skill in the art is capable of writing computer code or identifying appropriate hardware and/or circuits to implement the disclosed invention without difficulty, based on the flow diagrams and associated description in this specification, for example.

Therefore, disclosure of a particular set of program code instructions or detailed hardware devices is not considered necessary for an adequate understanding of how to make and use the invention. The inventive functionality of the claimed computer-implemented processes is explained in the above description and in conjunction with the drawing figures, which may illustrate various process flows.

In one or more exemplary aspects, the functions described may be implemented in hardware, software, firmware, or any combination thereof. If implemented in software, the functions may be embodied in computer-executable instructions or code stored on a computer-readable medium. Computer-readable media include any available media that may be accessed by a computer or similar computing or communication device. By way of example, and not limitation, such computer-readable media may comprise RAM, ROM, EEPROM, NAND flash, NOR flash, M-RAM, P-RAM, R-RAM, CD-ROM or other optical, magnetic, solid-state, etc., data storage media. It should be noted that a combination of a non-transitory computer-readable storage medium and the computer-executable logic or instructions stored therein for execution by a processor defines a “computer program product” as that term is understood in the patent lexicon.

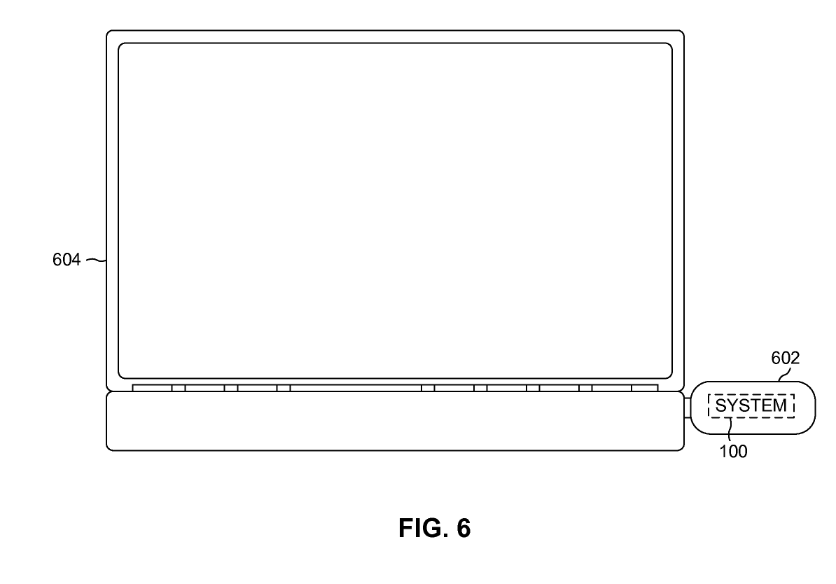

As illustrated in FIG. 6, in an exemplary embodiment the above-described system 100 may be included in a wireless modem 602 of a type that is pluggable into a Universal Serial Bus (“USB”) port of a laptop computer 604 or similar device. A potential problem is that modem 602 not only may lack sufficient memory to contain the entire software image, but modem 602 also may not be capable of paging from a memory (not shown) within computer 604. Even in an instance in which modem 602 is capable of paging from a memory within laptop computer 604, the latencies may exceed the latency tolerances of some or all tasks 108. This exemplary embodiment addresses this potential problem by providing the above-described paging from memory 104 and decompression into memory 104.

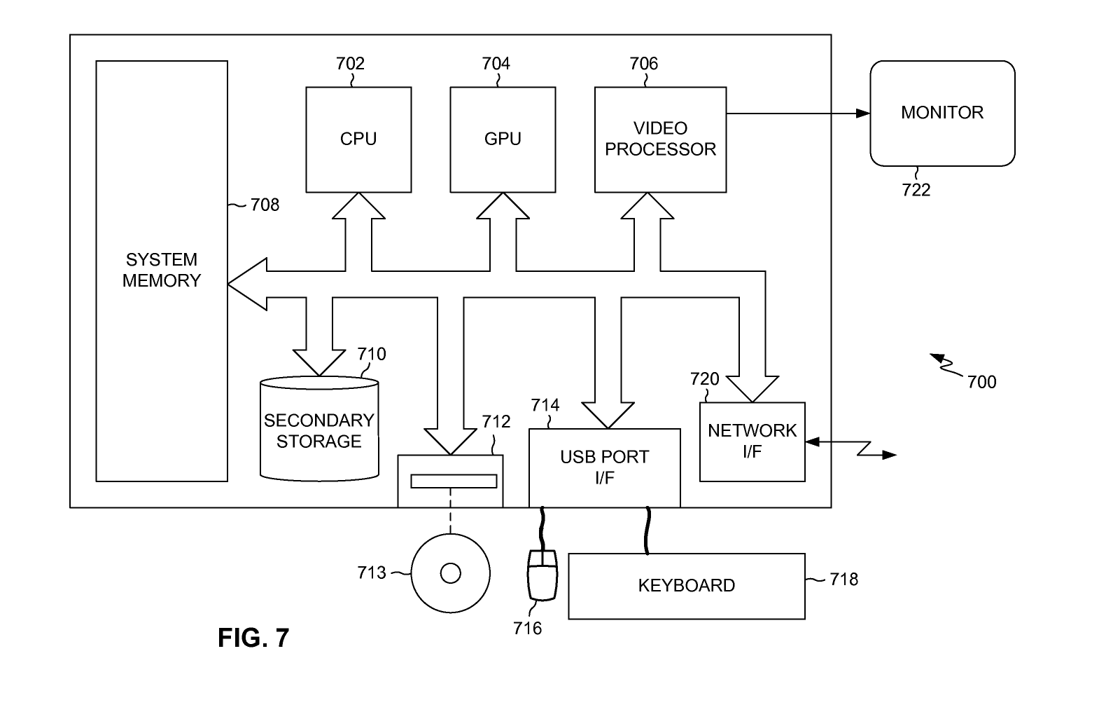

As illustrated in FIG. 7, in other exemplary embodiments the above-described system 100 (FIG. 1) may be included in any of a number of different types of processors of a computer system 700 or similar computing device. In one exemplary embodiment, system 100 can be included in a central processing unit (“CPU”) 702. In another exemplary embodiment, system 100 can be included in a graphics processing unit (“GPU”) 704. In still another exemplary embodiment, system 100 can be included in a video processor 706.

In such exemplary embodiments, computer system 700 may further include a system memory 708 and mass-storage devices, such as a non-removable media (e.g., FLASH memory, eMMC, magnetic disk, etc.) data storage 710 and a removable-media drive 712 (e.g., DVD-ROM, CD-ROM, Blu-ray disc, etc.). For example, removable-media drive 712 may accept a DVD-ROM 713. The terms “disk” and “disc,” as used herein, include compact disc (“CD”), laser disc, optical disc, digital versatile disc (“DVD”), floppy disk and Blu-ray disc. Combinations of the above are also included within the scope of computer-readable media. Computer system 700 also includes a USB port 714, to which user interface devices or other peripheral devices, such as a mouse 716 and a keyboard 718, may be connected. In addition, computer system 700 may include a network interface 720 to enable communication between computer system 700 and an external network, such as the Internet. User interface peripheral devices may also include a video monitor 722, which may be connected to video processor 706.

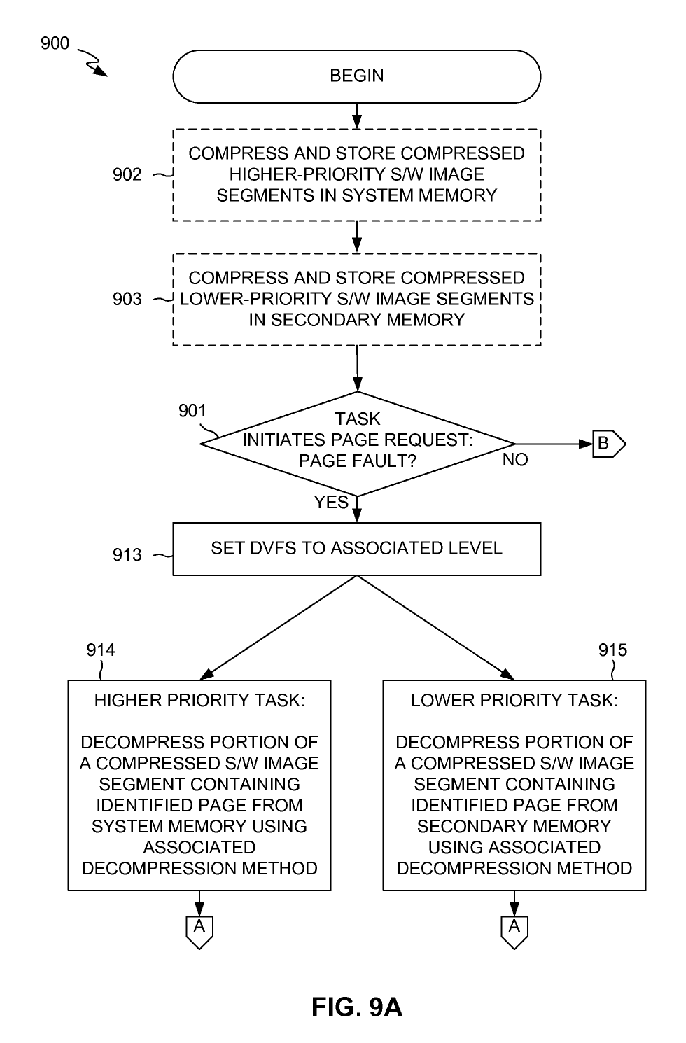

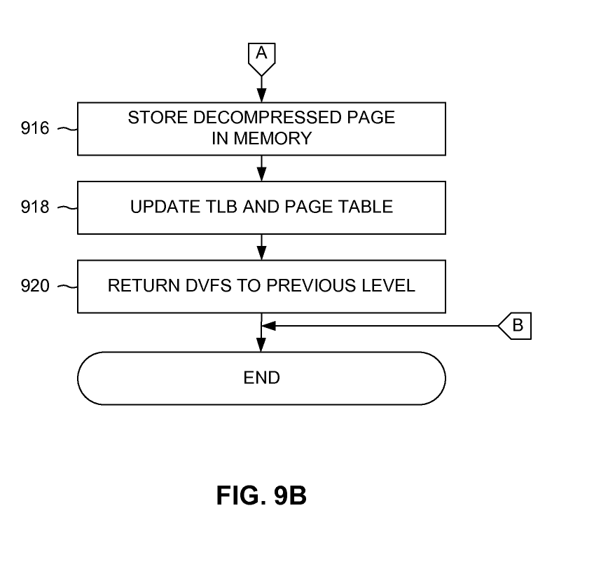

In FIGS. 9A-9B, an exemplary method 900 is illustrated that is similar to the exemplary method 500 described above with regard to FIGS. 5A-5B. Blocks 902 and 903 are similar to above-described block 502 in that software image segments are compressed and stored in a memory. However, unlike in exemplary method 500, in exemplary method 900 a distinction is made between software image segments associated with higher-priority tasks and software image segments associated with lower-priority tasks. As indicated by block 902, software image segments associated with higher-priority tasks are compressed and stored in the high-speed system memory, such as above-described system memory 104 (FIG. 1) or above-described system memory 708 (FIG. 7), in the same manner described above with regard to block 502. However, as indicated by block 903, software image segments associated with lower-priority tasks are compressed and stored in a secondary memory or similar data storage that is characterized by a higher latency, i.e., lower speed, than the system memory. Such a secondary memory may be, for example, FLASH memory, such as above-described data storage 710 (FIG. 7). Alternatively, with regard to the embodiment illustrated in FIG. 6, such a secondary memory (e.g., FLASH memory) may be included in computer 604.

Block 901 is similar to above-described block 501. As described above with regard to block 501, if it is determined that a page fault occurred, then a portion of the software image segment that is associated with the requesting task is obtained and decompressed. As indicated by block 914, in the case of the requesting task having a high priority and/or low latency tolerance, the software image segment portion to be decompressed is retrieved from the system memory, where that software image segment had been stored in accordance with above-described block 902. In contrast, as indicated by block 915, in the case of the requesting task having a low priority and/or high latency tolerance, the software image segment portion to be decompressed is retrieved from the secondary memory, where that software image segment had been stored in accordance with above-described block 903. In the case of either block 914 or 915, this decompression is performed using decompression logic associated with the compressed software image segment containing the requested page, as in the other embodiments described above. Thus, in the same manner as described above with regard to exemplary methods 200 and 500, in exemplary method 900 the decompression logic that is employed is associated with a compression characteristic, i.e., combination of one or more of compression algorithm, compression block size, and DVFS setting, associated with the priority and/or latency tolerance of the requesting task.

Referring again to the embodiment illustrated in FIG. 6, wireless modem 602 may employ such compression-based paging from its internal system memory in response to page requests initiated by higher-priority tasks but employ the same type of compression-based paging from a secondary memory within computer 604 in response to page requests initiated by lower-priority tasks.

Block 913 is similar to above-described block 513 in that a DVFS characteristic may be set temporarily and used while decompression is being performed, then returned (block 920) to its previous setting. Of course, it the DVFS characteristic is already set to a level or setting associated with the requesting task 108, it need not be set again to the same level or setting per block 913, and can remain at its then-current setting. Continuing to FIG. 5B, block 916 is similar to above-described block 516 in that the decompressed page is then stored in the high-speed system memory. Blocks 918 and 920 are similar to above-described blocks 518 and 520, respectively. Thus, in an instance in which two or more decompressions are to be performed in immediate succession, and following one such decompression the DVFS characteristic is already set to a level or setting associated with the requesting task 108 associated with the next decompression, the DVFS characteristic need not be returned to its previous level or setting per block 920, and can remain at its then-current setting.

In a particular aspect, one or more of the method steps described herein (such as described above with regard to FIGS. 2, 5A-5B and 9A-9B) may be stored in the memory 708 as computer program instructions. These instructions may be executed by the CPU 702, the GPU 704, the video processor 706, or another processor, to perform the methods described herein. Further, the CPU 702, the GPU 704, the video processor 706, or the memory 708, or a combination thereof, as configured by means of the computer program instructions, may serve as a means for performing one or more of the method steps described herein.

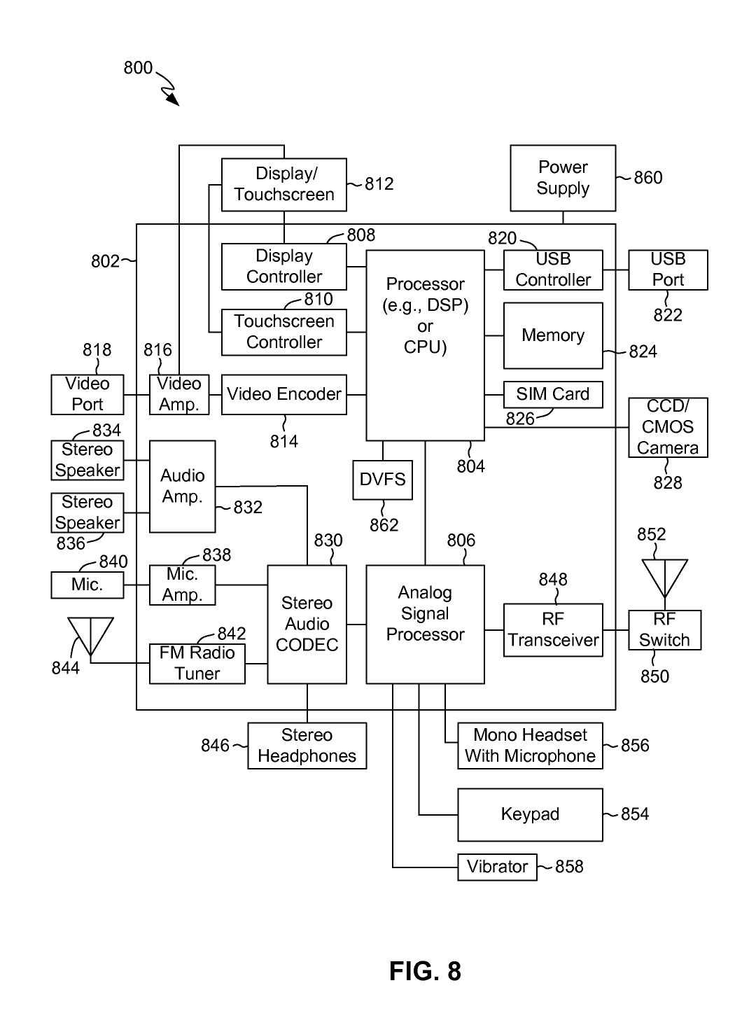

As illustrated in FIG. 8, another type of computing device in which the above-described system 100 (FIG. 1) may be included is a portable communication device 800, such as a mobile telephone. Portable communication device 800 includes an on-chip system 802 that includes a CPU or DSP 804 and an analog signal processor 806 that are coupled together. The DSP 804 may be configured to operate in the manner described above with respect to the above-described paging and decompression methods. A display controller 808 and a touchscreen controller 810 are coupled to the DSP 804. A touchscreen display 812 external to the on-chip system 802 is coupled to the display controller 808 and the touchscreen controller 810. A video encoder 814, e.g., a phase-alternating line (“PAL”) encoder, a sequential couleur avec memoire (“SECAM”) encoder, a national television system(s) committee (“NTSC”) encoder or any other video encoder, is coupled to the DSP 804. Further, a video amplifier 816 is coupled to the video encoder 814 and the touchscreen display 812. A video port 818 is coupled to the video amplifier 816. A USB controller 820 is coupled to the DSP 804. A USB port 822 is coupled to the USB controller 820. A memory 824, which may operate in the manner described above with regard to memory 104 (FIG. 1), is coupled to the DSP 804. A subscriber identity module (“SIM”) card 826 and a digital camera 828 also may be coupled to the DSP 804. In an exemplary aspect, the digital camera 828 is a charge-coupled device (“CCD”) camera or a complementary metal-oxide semiconductor (“CMOS”) camera.

A stereo audio CODEC 830 may be coupled to the analog signal processor 806. Also, an audio amplifier 832 may be coupled to the stereo audio CODEC 830. In an exemplary aspect, a first stereo speaker 834 and a second stereo speaker 836 are coupled to the audio amplifier 832. In addition, a microphone amplifier 838 may be coupled to the stereo audio CODEC 830. A microphone 840 may be coupled to the microphone amplifier 838. In a particular aspect, a frequency modulation (“FM”) radio tuner 842 may be coupled to the stereo audio CODEC 830. Also, an FM antenna 844 is coupled to the FM radio tuner 842. Further, stereo headphones 846 may be coupled to the stereo audio CODEC 830.

A radio frequency (“RF”) transceiver 848 may be coupled to the analog signal processor 806. An RF switch 850 may be coupled between the RF transceiver 848 and an RF antenna 852. The RF transceiver 848 may be configured to communicate with conventional terrestrial communications networks, such as mobile telephone networks, as well as with global positioning system (“GPS”) satellites.

A mono headset with a microphone 856 may be coupled to the analog signal processor 806. Further, a vibrator device 858 may be coupled to the analog signal processor 806. A power supply 860 may be coupled to the on-chip system 802. In a particular aspect, the power supply 860 is a direct current (“DC”) power supply that provides power to the various components of the portable communication device 800 that require power. Further, in a particular aspect, the power supply is a rechargeable DC battery or a DC power supply that is derived from an alternating current (“AC”) to DC transformer that is connected to an AC power source.

A DVFS controller 862 may be coupled to DSP 804. DVFS controller 862 may respond to control signals received from DSP 804 by adjusting a DVFS setting that affects a DVFS characteristic, such as a system clock frequency applied to DSP 804.

A keypad 854 may be coupled to the analog signal processor 806. The touchscreen display 812, the video port 818, the USB port 822, the camera 828, the first stereo speaker 834, the second stereo speaker 836, the microphone 840, the FM antenna 844, the stereo headphones 846, the RF switch 850, the RF antenna 852, the keypad 854, the mono headset 856, the vibrator 858, and the power supply 860 are external to the on-chip system 802.

In a particular aspect, one or more of the method steps described herein (such as described above with regard to FIGS. 2 and 5A-5B) may be stored in the memory 824 as computer program instructions. These instructions may be executed by the DSP 804, the analog signal processor 806, or another processor, to perform the methods described herein. Further, the DSP 804, the analog signal processor 806, or the memory 112, or a combination thereof, as configured by means of the computer program instructions, may serve as a means for performing one or more of the method steps described herein.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for demand paging in a processing system comprising a processor and one or more memories, the one or more memories including a system memory, the method comprising:
storing a plurality of compressed software image segments in at least one of the one or more memories, each compressed software image segment associated with at least one software task of a plurality of software tasks, each compressed software image segment comprising one or more pages compressed in accordance with a compression characteristic associated with the compressed software image segment and different from compression characteristics associated with all other compressed software image segments; and
determining whether a page request associated with an executing software task identifies a page stored in the system memory;
decompressing a portion of one of the compressed software image segments containing an identified page into a decompressed page if the identified page is not stored in the system memory; and
storing the decompressed page in the system memory in response to the page request.

2. The method of claim 1, wherein at least one of the compressed software image segments is associated with a group of two or more software tasks.

3. The method of claim 1, wherein the compression characteristic comprises one or more of a compression algorithm and a compression block size.

4. The method of claim 1, wherein:
storing a plurality of compressed software image segments comprises storing a first plurality of compressed software image segments in the system memory and storing a second plurality of compressed software image segments in a secondary memory having a higher latency than the system memory; and
decompressing a portion of one of the compressed software image segments containing an identified page into a decompressed page if the identified page is not stored in the system memory comprises decompressing a portion of one of the compressed software image segments stored in one of the system memory and the secondary memory.

5. The method of claim 1, wherein each compressed software image segment is further associated with a dynamic voltage and frequency scaling (DVFS) characteristic different from DVFS characteristics of all other compressed software image segments, and the method further comprises setting a DVFS control of the processing system to the DVFS characteristic associated with the one of the compressed software image segments containing the identified page.

6. The method of claim 1, wherein decompressing a portion of one of the compressed software image segments comprises decompressing a portion of a first compressed software image segment using decompression hardware logic and a portion of a second compressed software image segment using decompression software logic.

7. The method of claim 1, wherein the processing system is included in a portable computing device comprising at least one of a mobile telephone, a personal digital assistant, a pager, a smartphone, a navigation device, and a hand-held computer with a wireless connection or link.

8. A system for paging, comprising:
one or more memories including a system memory, at least one of the one or more memories configured to store a plurality of compressed software image segments in the memory, each compressed software image segment associated with at least one software task of a plurality of software tasks, each compressed software image segment comprising one or more pages compressed in accordance with a compression characteristic associated with the compressed software image segment and different from compression characteristics associated with all other compressed software image segments; and
a processor configured to:
determine whether a page request associated with an executing software task identifies a page stored in the system memory;
decompress a portion of one of the compressed software image segments containing an identified page into a decompressed page if the identified page is not stored in the system memory; and
store the decompressed page in the system memory in response to the page request.

9. The system of claim 8, wherein at least one of the compressed software image segments corresponds to a group of two or more software tasks.

10. The system of claim 8, wherein the compression characteristic comprises one or more of a compression algorithm and a compression block size.

11. The system of claim 8, wherein the compression characteristic comprises a combination of compression algorithm and compression block size.

12. The system of claim 8, wherein:
the system memory is configured to store a first plurality of compressed software image segments, and the system further comprises a secondary memory configured to store a second plurality of compressed software image segments, the secondary memory having a higher latency than the system memory; and
the processor is configured to decompress a portion of one of the compressed software image segments containing an identified page into a decompressed page if the identified page is not stored in the system memory by being configured to decompress a portion of one of the compressed software image segments stored in one of the system memory and the secondary memory.

13. The system of claim 8, wherein each compressed software image segment further corresponds to a dynamic voltage and frequency scaling (DVFS) characteristic different from DVFS characteristics of all other compressed software image segments, and the processor is further configured to set a DVFS control of the processing system to the DVFS characteristic associated with the one of the compressed software image segments containing the identified page.

14. The system of claim 8, wherein the processor is configured to decompress a portion of a first compressed software image segment using decompression hardware logic and a portion of a second compressed software image segment using decompression software logic.

15. The system of claim 8, wherein the memory and processor are included in a portable computing device comprising at least one of a mobile telephone, a personal digital assistant, a pager, a smartphone, a navigation device, and a hand-held computer with a wireless connection or link.

16. A system for demand paging in a processing system comprising a processor and one or more memories including a system memory, the system comprising:
means for storing a plurality of compressed software image segments in at least one of the one or more memories, each compressed software image segment associated with at least one software task of a plurality of software tasks, each compressed software image segment comprising one or more pages compressed in accordance with a compression characteristic associated with the compressed software image segment and different from compression characteristics associated with all other compressed software image segments; and
means for determining whether a page request associated with an executing software task identifies a page stored in the system memory;
means for decompressing a portion of one of the compressed software image segments containing an identified page into a decompressed page if the identified page is not stored in the system memory; and
means for storing the decompressed page in the system memory in response to the page request.

17. The system of claim 16, wherein at least one of the compressed software image segments is associated with a group of two or more software tasks.

18. The system of claim 16, wherein the compression characteristic comprises one or more of a compression algorithm and a compression block size.

19. The system of claim 16, wherein the compression characteristic comprises a combination of compression algorithm and compression block size.

20. The system of claim 16, wherein:
the means for storing comprises a means for storing a first plurality of compressed software image segments in the system memory and a means for storing a second plurality of compressed software image segments in a secondary memory having a higher latency than the system memory; and
the means for decompressing comprises a means for decompressing a portion of one of the compressed software image segments stored in one of the system memory and the secondary memory.

21. The system of claim 16, wherein each compressed software image segment is further associated with a dynamic voltage and frequency scaling (DVFS) characteristic different from DVFS characteristics of all other compressed software image segments, and the system further comprises means for setting a DVFS control of the processing system to the DVFS characteristic associated with the one of the compressed software image segments containing the identified page.

22. The system of claim 16, wherein decompressing a portion of one of the compressed software image segments comprises decompressing a portion of a first compressed software image segment using decompression hardware logic and a portion of a second compressed software image segment using decompression software logic.

23. The system of claim 16, wherein the processing system is included in a portable computing device comprising at least one of a mobile telephone, a personal digital assistant, a pager, a smartphone, a navigation device, and a hand-held computer with a wireless connection or link.

24. A computer program product comprising computer-executable logic embodied in a non-transitory storage medium, execution of the logic by the processor configuring the processor to:
determine whether a page request associated with an executing software task identifies a page stored in a system memory, the system memory included in one or more memories accessible by the processor, at least one of the one or more memories having stored therein a plurality of compressed software image segments, each compressed software image segment associated with at least one software task of a plurality of software tasks, each compressed software image segment comprising one or more pages compressed in accordance with a compression characteristic associated with the compressed software image segment and different from compression characteristics of all other compressed software image segments;
decompress one of the compressed software image segments containing an identified page into a decompressed page if the identified page is not stored in the system memory; and
store the decompressed page in the system memory in response to the page request.

25. The computer program product of claim 24, wherein at least one of the compressed software image segments is associated with a group of two or more software tasks.

26. The computer program product of claim 24, wherein the compression characteristic comprises one or more of a compression algorithm and a compression block size.

27. The computer program product of claim 24, wherein:
execution of the logic by the processor configures the processor to store a plurality of compressed software image segments by configuring the processor to store a first plurality of compressed software image segments in a system memory and store a second plurality of compressed software image segments in a secondary memory having a higher latency than the system memory; and
execution of the logic by the processor configures the processor to decompress a portion of one of the compressed software image segments containing an identified page into a decompressed page if the identified page is not stored in the system memory by configuring the processor to decompress a portion of one of the compressed software image segments stored in one of the system memory and the secondary memory.

28. The computer program product of claim 24, wherein each compressed software image segment is further associated with a dynamic voltage and frequency scaling (DVFS) characteristic different from DVFS characteristics of all other compressed software image segments, and the method further comprises setting a DVFS control of the processing system to the DVFS characteristic associated with the one of the compressed software image segments containing the identified page.

29. The computer program product of claim 24, wherein decompressing a portion of one of the compressed software image segments comprises decompressing a portion of a first compressed software image segment using decompression hardware logic and a portion of a second compressed software image segment using decompression software logic.

30. The computer program product of claim 24, wherein the processor is included in a portable computing device comprising at least one of a mobile telephone, a personal digital assistant, a pager, a smartphone, a navigation device, and a hand-held computer with a wireless connection or link.
